(19) United States
(12) Patent Application Publication
(10) Pub. No.: US 2025/0027176 A1
(43) Pub. Date: Jan. 23, 2025

(54) Injection Regulation and Control Device and Method for Blast Furnace Low-Carbon Smelting

(71) Applicants: Changli Xingguo Precision Parts Co., LTD, Qinhuangdao Heibei (CN); Shanghai University, Shanghai (CN)

(72) Inventors: Guocheng ZHOU, Qinhuangdao Heibei (CN); Kai ZHU, Shanghai (CN); Quanli LIU, Qinhuangdao Heibei (CN); Yuwen ZHANG, Shanghai (CN); Xionggang LU, Shanghai (CN); Yuwen YANG, Qinhuangdao Heibei (CN)

(21) Appl. No.: 18/714,706

(22) PCT Filed: Dec. 4, 2022
(86) PCT No.: PCT/CN2022/086288

§ 371 Date: May 30, 2024

(30) Foreign Application Priority Data
Dec. 3, 2021 (CN) 202111468019.5

(51) Int. Cl. C21B 5/00; C21B 5/06; C21B 7/16

(52) U.S. Cl. CPC C21B 5/001; C21B 5/06; C21B 7/163; C21B 2005/005; C21B 2100/282

(57) ABSTRACT

An injection regulation and control device includes blast furnace tuyeres for introducing rich oxygen or pure oxygen to form tuyere raceways. Temperature-adjusting injection openings are evenly formed in the circumferential direction of a blast furnace and inject a hydrocarbon component-containing injection object to the blast furnace. The temperature-adjusting injection openings are located, in an axial direction, within a height range where a soft melting dripping zone is located and are not lower than the positions of the blast furnace tuyeres. The hydrocarbon component-containing injection objects are enabled to undergo a thermal cracking reaction by utilizing the temperature in the vicinity of the tuyere raceways to form a hydrocarbon thermal cracking heat absorption area. Gas products generated by the thermal cracking reaction of the hydrocarbon component-containing injection objects increase the blast furnace gas volume. Redundant heat in a lower high-temperature area is carried to the upper part of the blast furnace.

### TECHNICAL FIELD

The present disclosure relates to the technical field of blast furnace metallurgy, and in particular, to an injection regulation and control device and method for oxygen blast furnace low-carbon smelting.

### BACKGROUND

During production of a blast furnace, iron ore, coke and fluxes for slagging (limestone) are loaded from the top of the furnace, and preheated air is blown into the furnace from tuyeres located at the lower part of the furnace along the furnace circumference. At high temperatures, the carbon in the coke (some blast furnaces also inject auxiliary fuels such as pulverized coal, heavy oil, and natural gas) is combusted with the oxygen blown into the air to generate carbon monoxide and hydrogen. During the process of rising in the furnace, the oxygen in the iron ore is removed, thereby reducing to obtain iron. The molten iron produced is discharged from an iron mouth. Unreduced impurities in the iron ore combine with the fluxes such as limestone to form slag, which is discharged from a slag outlet. The produced gas is discharged from the top of the furnace, and used as a fuel for hot blast furnaces, heating furnaces, coke ovens, boilers, and the like after being dedusted. The main products of blast furnace smelting are pig iron, as well as by-products including blast furnace slag and blast furnace gas.

As the main iron-making process at present, blast furnace has developed for hundreds of years, and its carbon consumption has approached the theoretical minimum value of this process, making it difficult to make significant breakthroughs. The emerging oxygen-enriched blast furnace or oxygen blast furnace iron-making process employs high-concentration oxygen or pure oxygen instead of the traditional hot air, which can not only promote the combustion of pulverized coal and achieve a significant increase in the amount of coal injection, but also makes the nitrogen content in the top gas low and enables CO₂ to be easily separated out, so that top gas cycle is realized, and the emission of CO₂ is further minimized. Since the 1980s, metallurgists at home and abroad had begun to explore and research pure oxygen smelting technologies, but in the end they could not solve the technical bottleneck of oxygen blast furnaces, making it impossible to achieve industrial application of this process. One of the key technical difficulties to be solved urgently in an oxygen blast furnace is that high oxygen enrichment (total oxygen) results in overhigh theoretical combustion temperature, causing changes in the temperature difference inside the blast furnace, so that the interior of the furnace is hot at the lower part and cold at the upper part. Almost all of the heat in the blast furnace comes from the combustion heat of the fuel in tuyere raceways and the physical heat brought in by the hot air. The thermal state of a hearth not only affects the slag iron temperature (i.e., hearth temperature), but also affects the shape of a soft melting zone, the distribution of gas flow, and the reduction reaction of iron oxides, a main indicator of which is the theoretical combustion temperature at the tuyere raceways.

Research has shown that the theoretical combustion temperature increases by 43° C. when the blast oxygen enrichment rate increases by 1%. The current methods for adjusting the thermal state of an oxygen blast furnace are humidification and top gas cycle injection. Humidification will lead to an overall decrease in gas utilization efficiency and a significant increase in fuel ratio, with a limited degree of regulation. The CO₂ in the top gas of is separated out by means of circulating injection through tuyeres, and the circulating gas serves as a heat carrier to bring the excess heat from the lower part to the upper part, which can alleviate the phenomenon that the oxygen blast furnace is “hot at the lower part and cold at the upper part” to a certain extent. However, the top gas is injected by the tuyeres circularly, causing combustion in the tuyere area, further exacerbating the phenomenon that the oxygen blast furnace is “hot at the lower part”.

### SUMMARY

The present disclosure provides an injection regulation and control device and method for blast furnace low-carbon smelting. Due to configuration of temperature-adjusting injection openings for injecting hydrocarbon component-containing injection objects to a blast furnace, gas products generated by a thermal cracking reaction of the hydrocarbon component-containing injection objects increase the blast furnace gas volume, and redundant heat in a lower high-temperature area is carried to the upper part of the blast furnace at the same time; and therefore, the problem that an oxygen-enriched blast furnace or an oxygen blast furnace is “hot at the lower part and cold at the upper part” is flexibly solved.

The technical solution of the present disclosure is as follows:

An injection regulation and control device for blast furnace low-carbon smelting includes blast furnace tuyeres used for introducing rich oxygen or pure oxygen to form tuyere raceways; a plurality of temperature-adjusting injection openings are evenly formed in the circumferential direction of a blast furnace, each of the temperature-adjusting injection openings injects a hydrocarbon component-containing injection object to the blast furnace, and the temperature-adjusting injection openings are located, in an axial direction, within a height range where a soft melting dripping zone is located, and are not lower than the positions where the blast furnace tuyeres are located; and the hydrocarbon component-containing injection objects are enabled to undergo a thermal cracking reaction by utilizing the temperature in the vicinity of the tuyere raceways to form a hydrocarbon thermal cracking heat absorption area.

Preferably, the hydrocarbon component-containing injection objects include methane, and one or more of natural gas, coke oven gas, and liquefied petroleum gas.

Preferably, each of the temperature-adjusting injection openings is reserved just above a middle position between the two adjacent blast furnace tuyeres.

Preferably, the injection regulation and control device for blast furnace low-carbon smelting further includes a furnace top CO₂ separation system, and the furnace top CO₂ separation system is configured to separate out CO₂ from top gas in the blast furnace so as to obtain the top gas rich in CO and H₂.

Preferably, the top gas rich in CO and H₂ is re-injected into the blast furnace through the blast furnace tuyeres.

Preferably, a plurality of furnace stack injection openings are formed in the middle position of the blast furnace, and the furnace stack injection openings are configured to re-inject the top gas rich in CO and H₂ into the blast furnace.

Preferably, the injection regulation and control device for blast furnace low-carbon smelting further includes a preheating system, and the preheating system is configured to heat up the top gas rich in CO and H₂.

Preferably, the products of the thermal cracking reaction are carbon and hydrogen.

Preferably, the furnace stack injection openings are evenly formed within the height range below the soft melting dripping zone in the circumferential direction of the blast furnace, and are located above the temperature-adjusting injection openings.

A injection regulation and control method for blast furnace low-carbon smelting employs the injection regulation and control device for blast furnace low-carbon smelting to perform injection regulation and control on blast furnace low-carbon smelting; the hydrocarbon component-containing injection objects are ejected through the temperature-adjusting injection openings to undergo the thermal cracking reaction, so as to reduce the temperature of the tuyere raceways and the vicinity of a blast furnace hearth; and gas products generated by the thermal cracking reaction increase the blast furnace gas volume, and thus redundant heat of the tuyere raceways is carried to the upper part of the blast furnace.

Compared with the prior art, the present disclosure has the following advantages:
1. According to the injection regulation and control device and method for blast furnace low-carbon smelting provided by the present disclosure, the hydrocarbon component-containing injection objects are ejected through the temperature-adjusting injection openings to undergo the thermal cracking (strong endothermic) reaction in the vicinity of temperature-adjusting injection openings instead of the traditional exothermic reaction of blast furnace tuyere injection oxidation combustion. The occurrence of thermal cracking (strong endothermic) reaction effectively reduces the temperature of the tuyere raceways and the vicinity of the blast furnace hearth.
2. According to the injection regulation and control device and method for blast furnace low-carbon smelting provided by the present disclosure, the hydrocarbon component-containing injection objects and the gas products of the thermal cracking reaction increase the blast furnace gas volume, and the redundant heat in the lower high-temperature area can be carried to the upper part of the blast furnace; and therefore, the problem that the oxygen-enriched blast furnace or the oxygen blast furnace is “hot at the lower part and cold at the upper part” is flexibly solved. The hydrocarbon component-containing injection objects undergo thermal cracking below the soft melting dripping zone, producing a large amount of hydrogen. As the gas rises, the ability of hydrogen to reduce iron ore in the high-temperature area is fully exerted, reducing the direct reduction (strong endothermic reaction) of carbon and lowering the coke ratio.
3. According to the injection regulation and control device and method for blast furnace low-carbon smelting provided by the present disclosure, the hydrogen generated by the cracking reaction can directly participate in the reduction of iron ore, thereby reducing the direct reduction of carbon and further reducing carbon emissions.
4. According to the injection regulation and control device and method for blast furnace

low-carbon smelting provided by the present disclosure, rich oxygen or pure oxygen is introduced through the blast furnace tuyeres, that is, an oxygen-enriched blast furnace is employed, making the nitrogen content in the top gas very low. The furnace top CO₂ separation system is adopted, so that CO₂ is easily separated out, and the top gas is fully recycled.

### BRIEF DESCRIPTION OF FIGURES

FIG. 1 is a schematic diagram of the front view structure of an injection regulation and control device for blast furnace low-carbon smelting provided by Embodiment 1 according to the present disclosure;

FIG. 2 is a perspective view of the top view structure of the injection regulation and control device for blast furnace low-carbon smelting as shown in FIG. 1;

FIG. 3 is a schematic diagram of the front view structure of an injection regulation and control device for blast furnace low-carbon smelting provided by Embodiment 2 according to the present disclosure; and

FIG. 4 is a schematic diagram of the front view structure of an injection regulation and control device for blast furnace low-carbon smelting provided by Embodiment 3 according to the present disclosure.

The following reference numerals on the drawings are described as follows: 1 denotes temperature-adjusting injection openings, 2 denotes blast furnace tuyeres, 3 denotes a hydrocarbon thermal cracking heat absorption area, 4 denotes tuyere raceways, 5 denotes a blast furnace wall, 6 denotes hydrocarbon component-containing injection objects, 7 denotes a blower device, 8 denotes a furnace top CO2 separation system, 9 denotes a gas preheating system, and 10 denotes furnace stack injection openings.

### DETAILED DESCRIPTION

In order to facilitate understanding of the present disclosure, the present disclosure will be described in more detail below with reference to the accompanying drawings and specific embodiments.

### Embodiment 1

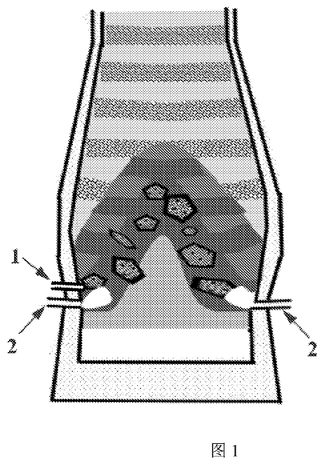

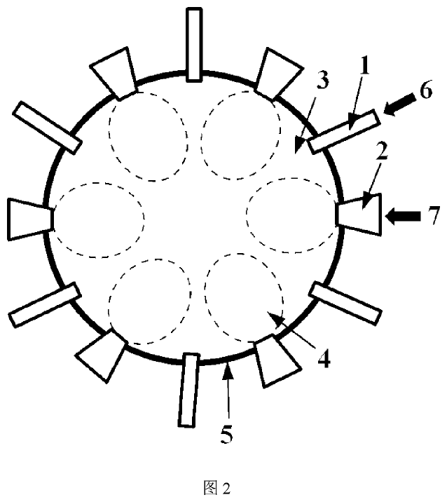

The front view and the perspective view of the top view structure of an injection regulation and control device for blast furnace low-carbon smelting according to the present disclosure are shown in FIG. 1 and FIG. 2, and each of temperature-adjusting injection openings 1 is reserved between two adjacent blast furnace tuyeres 2 at a middle position higher than the blast furnace tuyeres. In a novel oxygen-enriched blast furnace or pure oxygen blast furnace, when rich oxygen or pure oxygen is introduced into each of the blast furnace tuyeres 2, a tuyere raceway 4 will be formed, and a hydrocarbon component-containing injection object 6 is injected into the corresponding temperature-adjusting injection opening 1 at the same time. The hydrocarbon component-containing injection objects 6 do not pass through the tuyere raceways 4 and therefore do not participate in a combustion reaction. At high temperatures, these hydrocarbon component-containing injection objects 6 will undergo a thermal cracking reaction to form a hydrocarbon thermal cracking heat absorption area 3. The hydrocarbon component-containing injection objects 6 include methane, and one or more of natural gas, coke oven gas, and liquefied petroleum gas. The reaction equation of the thermal cracking reaction that occurs is as follows:

Methane: CH₄→C+2H₂

Ethane: C₂H₆→2C+3H₂

Propane: C₃H₈→3C+4H₂

Butane: C₄H₁₀→4C+5H₂

Propylene: C₃H₆→3C+3H₂

Butene: C₄H₈→4C+4H₂

Due to the formation of the thermal cracking heat absorption area 3, the temperature of the tuyere raceways 4 and the hearth temperature in the vicinity of the tuyere raceways 4 are effectively reduced. Moreover, the hydrocarbon component-containing injection objects 6 and the gas product H₂ of the thermal cracking reaction increase the blast furnace gas volume, and redundant heat in a lower high-temperature area is carried to the upper part of the blast furnace. In addition, the gas product H₂ will directly participate in the reduction of iron ore at the upper part of the blast furnace, reducing the direct reduction reaction (strong endothermic reaction) of carbon. The hydrocarbon component-containing injection objects 6 mainly contain C element and H element, and will not introduce other impurity gases, which is conducive to the separation of CO₂ from the top gas.

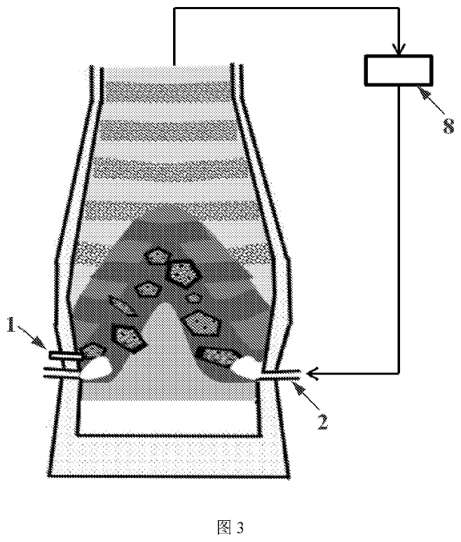

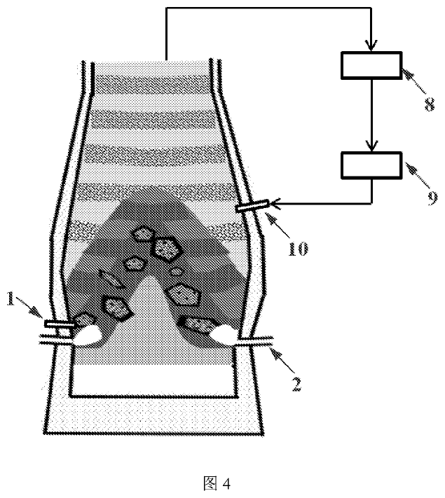

After CO₂ is separated out from the top gas by means of a CO₂ separation system 8, the top gas is mainly rich in CO and H₂ and thus can be recycled. One way, as shown in FIG. 3, is to inject the top gas rich in CO and H₂ into the blast furnace together with the rich oxygen/pure oxygen by means of a blower device 7 through the blast furnace tuyeres 2 to participate in the combustion reaction. The second way, as shown in FIG. 4, is to heat up the top gas rich in CO and H₂ by means of a preheating system 9, and then convey the heated top gas into the blast furnace through furnace stack injection openings 10 formed in a furnace stack so as to enable same to participate in the reduction reaction.

A injection regulation and control method for blast furnace low-carbon smelting employs the injection regulation and control device for blast furnace low-carbon smelting to perform injection regulation and control on blast furnace low-carbon smelting; the hydrocarbon component-containing injection objects are ejected through the temperature-adjusting injection openings 1 to undergo the thermal cracking reaction, so as to reduce the temperature of the tuyere raceways 4 and the vicinity of a blast furnace hearth; and gas products generated by the thermal cracking reaction increase the blast furnace gas volume, and thus redundant heat of the tuyere raceways 4 is carried to the upper part of the blast furnace. The problem that the oxygen-enriched blast furnace or oxygen blast furnace is “hot at the lower part and cold at the upper part” is solved. The hydrocarbon component-containing injection objects undergo thermal cracking below the soft melting dripping zone, producing a large amount of hydrogen. As the gas rises, the ability of hydrogen to reduce iron ore in the high-temperature area is fully exerted, reducing the direct reduction (strong endothermic reaction) of carbon and lowering the coke ratio.

The foregoing descriptions are merely exemplary specific implementations of the present disclosure, but the protection scope of the present disclosure is not limited thereto. Any change or replacement that can be easily conceived of by those of ordinary skill in the art within the technical scope disclosed by the present disclosure shall be covered by the protection scope of the present disclosure. Therefore, the protection scope of the present disclosure should be subject to the protection scope of the claims.

1.-20. (canceled)

21. An injection regulation and control method for blast furnace low-carbon smelting, comprising the steps of:
introducing rich oxygen or pure oxygen into blast furnace tuyeres to form tuyere raceways inside a blast furnace;
enabling a plurality of temperature-adjusting injection openings to be evenly formed in the circumferential direction of the blast furnace, and enabling each of the temperature-adjusting injection openings to be reserved just above a middle position between the two adjacent blast furnace tuyeres, and the temperature-adjusting injection openings are located, in an axial direction, within a height range where a soft melting dripping zone is located, and are not lower than the positions where the blast furnace tuyeres are located;
enabling each of the temperature-adjusting injection openings to inject a hydrocarbon component-containing injection object to the blast furnace, and enabling the injected hydrocarbon component-containing injection objects not to pass through the tuyere raceways and not to further participate in a combustion reaction, instead, enabling the injected hydrocarbon component-containing injection objects to undergo a thermal cracking reaction by utilizing the temperature in the vicinity of the tuyere raceways to form a hydrocarbon thermal cracking heat absorption area, so as to reduce the temperature of the tuyere raceways and the vicinity of a blast furnace hearth;
the hydrocarbon component-containing injection objects comprising methane, and one or more of natural gas, coke oven gas, and liquefied petroleum gas, and thus gas products generated by the thermal cracking reaction being carbon and hydrogen;
the gas products generated by the thermal cracking reaction increasing the blast furnace gas volume, and thus redundant heat of the tuyere raceways being carried to the upper part of the blast furnace; and
enabling a plurality of furnace stack injection openings to be formed in the middle of the blast furnace, wherein top gas is separated out by a furnace top CO₂ separation system, and the furnace stack injection openings are configured to re-inject the top gas rich in CO and H₂ into the blast furnace after preheating.
